(19) United States
(12) Patent Application Publication
(10) Pub. No.: US 2010/0227194 A1
(43) Pub. Date: Sep. 9, 2010

(54) Quasi-Crystallie Compound and its Use as a Thermal Barrier Coating

(75) Inventor: Werner Stamm, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Muenchen (DE)

(21) Appl. No.: 12/225,328

(22) PCT Filed: Mar. 22, 2007
(86) PCT No.: PCT/EP2007/052732

§ 371 Date: Sep. 18, 2008

(30) Foreign Application Priority Data
Mar. 23, 2006 (EP) 06006053.0

(51) Int. Cl. B32B 15/04; C09D 1/00

(52) U.S. Cl. 428/621; 106/286.2; 428/457

(57) ABSTRACT

The invention relates to a compound with the nominal chemical composition Al_{w}CoₓM_{y} wherein M represents at least one of the elements selected from the group Ni, Cr, and at least 30 mass percent of the compound is a quasicrystalline structure or similar. The invention is characterized in that 70≦w≦76 and w+X+Y=100.

### CROSS REFERENCE TO RELATED APPLICATIONS

This application is the US National Stage of International Application No. PCT/EP2007/052732, filed Mar. 22, 2007 and claims the benefit thereof. The International Application claims the benefits of European application No. 06006053.0 filed Mar. 23, 2006, both of the applications are incorporated by reference herein in their entirety.

### FIELD OF INVENTION

The present invention relates to a compound of the nominal atomic composition Al_{w}COₓM_{y} where M is at least one element selected from the group consisting of Ni, Cr and at least 30 percent by mass of the compound is in the form of a quasi-crystalline structure or in approximate form, to a coating which consists of or contains the compound, to a layer system which comprises the coating and a metallic layer, and to the use of the compound as a thermal barrier coating for a component that is exposed to high temperatures.

### BACKGROUND OF THE INVENTION

When components are used at high temperatures and under corrosive conditions, it is in many cases necessary for them to be provided with protective coatings. For example, the use of thermal barrier coatings can not only increase the service life of the components but in some cases also allow the operating temperature to be raised, leading to efficiency control. This applies in particular to components that are used in gas or steam turbines.

Zirconium oxides, for example stabilized by yttrium oxides, are normally used for thermal barrier coatings of this type. Ceramic thermal barrier coatings of this type can be applied to a metallic substrate using processes such as plasma spraying. However, since the ceramic layers do not adhere sufficiently well to the metallic substrate, it is necessary first of all to apply a bonding base MCrAlY to be component, where M is at least one element selected from the group consisting of iron, cobalt, nickel and Y is an active element and stands for yttrium and/or silicon and/or a rare earth element or hafnium.

Applying two layers to the component that is to be protected is a complex process, and consequently efforts have been made to find alternative materials to the ceramic compounds. In the context of these efforts, quasi-crystalline materials have proven suitable, since they have a high resistance to corrosion and oxidation, a low thermal expansion, are suitable for processing to form coatings and in particular have a low thermal conductivity.

Quasi-crystals, in the narrow sense of the term, are phases which have a 5-, 10- or 12-way rotational symmetry, not compatible with the symmetry of the translation lattice of classic crystal phases. Approximates of quasi-crystals is the term used to describe translational periodic intermetallic compounds which have diffraction patterns with a 5, 8; 10 or 12 times absolute symmetry.

Quasi-crystalline alloys are described for example in U.S. Pat. No. 5,432,011. The alloys mentioned therein are used inter alia for coatings, which in turn are employed as thermal barrier coatings. However, the patent discloses a large number of possible alloys which may contain a very wide range of elements in numerous possible compositions.

DE 103 58 813 A1 also mentions quasi-crystalline alloys and their use as a coating. Said document provides extensive references to the prior art on quasi-crystalline alloys.

The quasi-crystalline alloys described contain rare and in particular also expensive metals, such as ruthenium, platinum or palladium. A further problem in producing the alloys is that in some cases they contain more than six different metals, which makes accurate weighing of the components difficult and in particular increases costs. Moreover, it is not always the case that a sufficient proportion of the alloy is in quasi-crystalline form or in approximate form, and the thermal conductivity is in some cases still too high for use as a thermal barrier coating.

### SUMMARY OF INVENTION

It is an object of the present invention to provide a compound which consists of a small number of inexpensive metallic constituents and in which at least 30 percent by mass is in the form of a quasi-crystalline structure or in approximate form. A further object of the invention is to develop a coating or a layer system using the compound and to employ the compound as a thermal barrier coating for a component.

According to the invention, the object is achieved by providing a compound of the nominal atomic composition Al_{w}CoₓM_{y}, in which 70≦w≦76 and w+x+y=100 and M represents one or two metals.

Therefore, the basic concept of the invention is that of providing a compound which consists of at most three or four metallic elements, which are all relatively inexpensive to purchase and in which aluminum forms the main constituent, in a range between 70 and 76 atomic percent.

Three Metallic Elements

In one configuration of the invention, M=Ni, 10<x≦15 and 10<y≦20. This compound consists of just three elements and in addition has a very good thermal stability.

Moreover, tests have shown that a compound with a particularly low thermal conductivity is obtained if M=Cr and 70≦w≦75, 10≦x≦15 and 10≦y≦20.

Four Metallic Elements

In a further embodiment of the invention, a compound, in addition to aluminum and cobalt, also comprises both chromium and nickel (M=Ni, Cr), where 70≦w<75.

Coating and Layer Systems

The compound can be applied to a substrate in the form of a coating. It may also be included as one of a plurality of constituents in a coating.

Moreover, it is possible to form a layer system with the aid of the coating according to the invention. It is preferable for a metallic layer to be arranged beneath the coating comprising the compound according to the invention.

Here, it has proven advantageous for the metallic layer to contain nickel and aluminum, preferably in an atomic ratio of 95:5.

The metallic layer may also be formed as a thin bonding layer, improving the adhesion of the coating.

If the layer system comprising coating and metallic layer is applied a number of times in succession, the result is a multiple layer system, which has a particularly good corrosion resistance and low thermal conductivity.

### BRIEF DESCRIPTION OF THE DRAWINGS

FIG. 1 identifies a steam turbine in accordance with the invention.

### DETAILED DESCRIPTION OF INVENTION

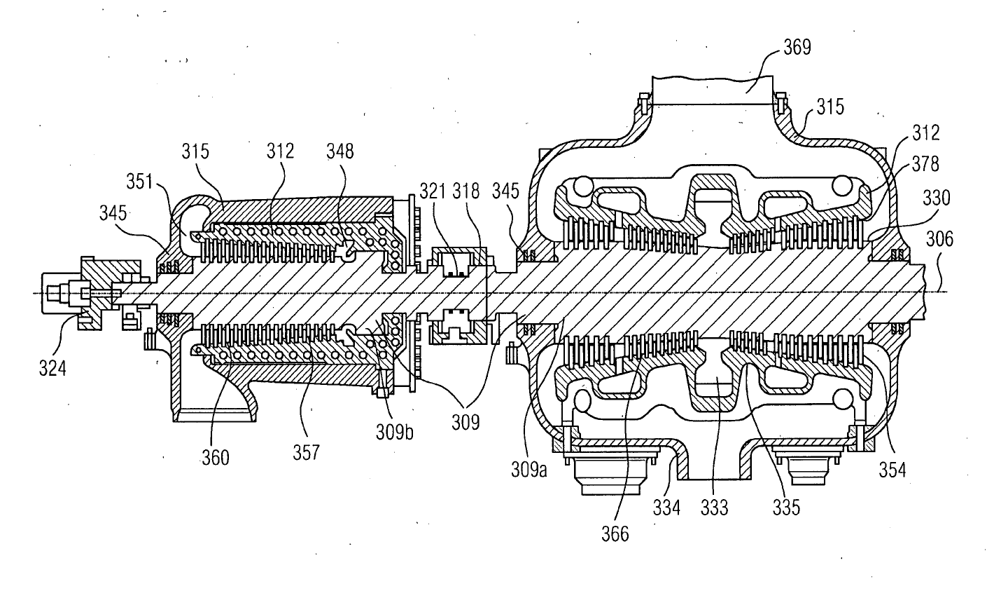

The compound according to the invention can also be used as a thermal barrier coating for a component 333, 357 (FIG. 1) that is exposed to high temperatures.

In the same way, it is also possible to use a compound which contains aluminum and manganese and in which at least 30 percent by mass is in the form of a quasi-crystalline structure or in approximate form.

The use according to the invention is suitable in particular for parts of turbines, in particular of a steam turbine 300, 303, such as turbine blades or vanes 357 (FIG. 1).

FIG. 1 illustrates a steam turbine 300, 303 with a turbine shaft 309 extending along an axis of rotation 306.

The steam turbine has a high-pressure part-turbine 300 and an intermediate-pressure part-turbine 303, each having an inner housing 312 and an outer housing 315 surrounding the inner housing. The high-pressure part-turbine 300 is, for example, a part-like design. The intermediate-pressure part-turbine 303 is for example of two-flow design. It is also possible for the intermediate-pressure part-turbine 303 to be of single-flow design.

Along the axis of rotation 306, a bearing 318 is arranged between the high-pressure part-turbine 300 and the intermediate-pressure part-turbine 303, the turbine shaft 309 having a bearing region 321 in the bearing 318. The turbine shaft 309 is mounted on a further bearing 324 next to the high-pressure part-turbine 300. In the region of this bearing 324, the high-pressure part-turbine 300 has a shaft seal 345. The turbine shaft 309 is sealed with respect to the outer housing 315 of the intermediate-pressure part-turbine 303 by two further shaft seals 345. Between a high-pressure steam inflow region 348 and a steam outlet region 351, the turbine shaft 309 in the high-pressure part-turbine 300 has the high-pressure rotor blading 357, which preferably includes the compound according to the invention as a coating. This high-pressure rotor blading 357, together with the associated rotor blades (not shown in more detail), constitutes a first blading region 360.

The intermediate-pressure part-turbine 303 has a central steam inflow region 333, which preferably includes a compound according to the invention as a coating. Assigned to the steam inflow region 333, the turbine shaft 309 has a radially symmetrical shaft shield 363, a cover plate, on the one hand for dividing the flow of steam between the two flows of the intermediate-pressure part-turbine 303 and also for preventing direct contact between the hot steam and the turbine shaft 309. The turbine shaft 309 has a second blading region 366 having the intermediate-pressure rotor blades 354 in the intermediate-pressure part-turbine 303. The hot steam flowing through the second blading region 366 flows out of the intermediate-pressure part-turbine 303 from an outflow connection piece 369 to a low-pressure part-turbine (not shown) which is connected downstream in terms of flow.

The turbine shaft 309 is composed for example of two turbine part-shafts 309a, 309b, which are fixedly connected to one another in the region of the bearing 318. Each turbine part-shaft 309a, 309b has a cooling duct 372, which is formed as a central bore 372a along the axis of rotation 306. The cooling duct 372 is connected to the steam exit region 351 via an inflow duct 375 having a radial bore 375a. In the intermediate-pressure part-turbine 303, the coolant duct 372 is connected to a cavity (not shown in more detail) beneath the shaft shield. The inflow ducts 375 are designed as a radial bore 375a, with the result that “cold” steam can flow out of the high-pressure part-turbine 300 into the central bore 372a. Via the outflow duct 372, which in particular also forms a radially oriented bore 375a, the steam passes through the bearing region 321 into the intermediate-pressure part-turbine 303 and there passes on to the lateral surface 330 of the turbine shaft 309 in the steam inflow region 333. The steam flowing through the cooling duct is at a significantly lower temperature than the reheated steam flowing into the steam inflow region 333, so that effective cooling of the first rotor blade rows 342 of the intermediate-pressure part-turbine 303 and of the lateral surface 330 in the region of these rotor blades rows 342 is ensured.

1.-14. (canceled)

15. A compound, comprising:
Al_{w}COₓM_{y},
where M is at least one element selected from the group consisting of Ni, Cr, and
at least 30 percent by mass of the compound is in the form of a quasi-crystalline structure,
70≦w≦76, and
w+x+y=100.

16. The compound as claimed in claim 15, wherein M=Cr and 70≦w≦75, 10≦x≦15 and 10≦y≦20.

17. The compound as claimed in claim 16, wherein 71≦w 74, 11≦x≦14 and 12≦y≦18.

18. The compound as claimed in claim 15, wherein M=Cr and Ni and 70≦w<75.

19. The compound as claimed in claim 18, wherein 71≦w≦74.

20. A layer system, comprising:
a substrate to be coated;
a coating arranged on the substrate, wherein the coating comprises:
Al_{w}COₓM_{y}, where
M is at least one element selected from the group consisting of Ni, Cr, and
at least 30 percent by mass of the compound is in the form of a quasi-crystalline structure,
70≦w≦76, and
w+x+y=100.

21. The layer system as claimed in claim 20, wherein the layer system further comprises a metallic layer.

22. The layer system as claimed in claim 21, wherein the metallic layer is arranged beneath the coating.

23. The layer system as claimed in claim 21, wherein the metallic layer is arranged above the coating.

24. The layer system as claimed in claim 21, wherein the metallic layer contains Ni and Al, in an atomic ratio of Ni=95 and Al=5.

25. The layer system as claimed in claim 21, wherein the metallic layer is formed as a thin bonding layer.

26. The layer system as claimed in claim 25, wherein the layer system comprises a further metallic bond layer arranged on the original coating layer and a further coating layer arranged on the further metallic bond layer.

27. A thermal barrier coating for a turbine component which is exposed to high temperatures, comprising:
a metallic bond coat; and
an insulative coating arranged on the metallic bond coat comprising:
Al_{w}COₓM_{y}, where
M is at least one element selected from the group consisting of Ni, Cr, and
at least 30 percent by mass of the compound is in the form of a quasi-crystalline structure,
70≦w≦76, and
w+x+y=100.

28. The thermal barrier coating as claimed in claim 27, wherein M=Cr and 70≦w≦75, 10≦x≦15 and 10≦y≦20.

29. The thermal barrier coating as claimed in claim 28 wherein 71≦w 74, 11≦x≦14 and 12≦y≦18.

30. The thermal barrier coating as claimed in claim 27, wherein M=Cr and Ni and 70≦w<75.

31. The thermal barrier coating as claimed in claim 30, wherein 71≦w≦74.

32. The thermal barrier coating as claimed in claim 27, wherein the component is a turbine blade or vane.
